(19) United States
(12) Patent Application Publication
(10) Pub. No.: US 2026/0161559 A1
(43) Pub. Date: Jun. 11, 2026

(54) DETECTING AND CORRECTING LOGICAL BLOCK ADDRESS MISMATCH CONDITIONS IN A MEMORY SYSTEM

(71) Applicant: Micron Technology, Inc., Boise, ID (US)

(72) Inventor: Sai Krishna MYLAVARAPU, Folsom, CA (US)

(21) Appl. No.: 19/362,222

(22) Filed: Oct. 17, 2025

Related U.S. Application Data
(60) Provisional application No. 63/728,387, filed on Dec. 5, 2024.

(51) Int. Cl. G06F 12/06

(52) U.S. Cl. CPC G06F 12/0653

(57) ABSTRACT

In some implementations, a memory system may receive a memory access request indicating a logical block address (LBA) associated with a portion of a nonvolatile memory subsystem of the memory system. The memory system may determine, using a logical-to-physical (L2P) data structure stored in a volatile memory subsystem of the memory system, a physical address associated with the LBA. The memory system may detect an LBA mismatch condition associated with the physical address. The memory system may perform a physical-to-logical (P2L) rebuild operation to determine a correct L2P association for the LBA. The memory system may store the correct L2P association in the L2P data structure.

### CROSS-REFERENCE TO RELATED APPLICATION

This Patent Application claims priority to U.S. Provisional Patent Application No. 63/728,387, filed on December 5, 2024, entitled “DETECTING AND CORRECTING LOGICAL BLOCK ADDRESS MISMATCH CONDITIONS IN A MEMORY SYSTEM,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to detecting and correcting logical block address mismatch conditions in a memory system.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or nonvolatile. Nonvolatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of detecting and correcting logical block address (LBA) mismatch conditions in a memory system.

FIG. 2 is a diagram illustrating an example of a logical-to-physical (L2P) table.

FIG. 3 is a diagram of an example implementation associated with detecting and correcting LBA mismatch conditions in a memory system.

FIG. 4 is a flowchart of an example method associated with detecting and correcting LBA mismatch conditions in a memory system.

FIG. 5 is a flowchart of an example method associated with detecting and correcting LBA mismatch conditions in a memory system.

### DETAILED DESCRIPTION

In modern data storage technologies, DRAM subsystems play a critical role in the overall system performance of solid-state drives (SSDs), particularly in the mapping of LBAs to physical block addresses (PBAs) through an L2P mapping process. However, the integrity of data maintained by DRAM subsystems can become compromised due to uncorrectable errors (e.g., row failures), significantly degrading system performance and posing a risk of data loss. In NAND-based SSD controllers, for example, such errors may lead to LBA mismatches, which disrupt the expected L2P lookups and contribute to additional wear and tear on the system, reducing its operational lifespan. As NAND-based SSD capacities continue to increase, the likelihood of encountering DRAM errors also escalates, affecting annual failure rates (AFRs). Current industry standards and pursuits to minimize these errors, such as aiming for one failure in time (FIT) per die, present challenges in both cost and scheduling, making such pursuits impractical for many applications.

Certain techniques aimed at mitigating the effects of DRAM errors predominantly focus on handling tag mismatches as they occur, effectively detecting issues without providing a mechanism for correction. This approach, while useful for preventing silent data corruption, does not address the persistence of errors within the DRAM itself, such as errors that will recurrently trigger AFR incidents each time the erroneous address is accessed. Although error correction codes (ECCs) could theoretically be introduced to rectify such DRAM issues, the integration of ECCs at the hardware level would introduce additional complexity to the system, causing unwanted increases in power consumption, latency, and system cost.

Some implementations described herein provide reduced occurrences of uncorrectable errors within a volatile memory subsystem (e.g., a DRAM subsystem) that impact system performance and data integrity. For example, some implementations described herein involve receiving a memory access request indicating an LBA and using an L2P data structure stored in the volatile memory subsystem to determine the physical address associated with the LBA. When an LBA mismatch condition is detected (e.g., based on a tag stored with data retrieved from the physical address), the system may perform a physical-to-logical (P2L) rebuild operation to determine the correct L2P association for the LBA, and/or the system may update the L2P data structure to include the correct L2P association for the LBA. In some implementations, the P2L rebuild process may be executed as part of either a soft or hard post-package repair (PPR) procedure associated with the volatile memory subsystem.

In this way, implementations described herein may efficiently mitigate the incidence of LBA mismatches, resulting in a reduced AFR of the DRAM subsystem and/or memory system as a whole. Some implementations described herein may optimize the use of existing hardware infrastructure and/or may be implemented through firmware updates, thus conserving resources by leveraging current systems without necessitating hardware redesigns or additional compensatory mechanisms. Additionally, or alternatively, some implementations described herein may effectively improve error correction capabilities, thus contributing to the system’s performance by maintaining data integrity and extending the SSD lifespan. Moreover, by avoiding reliance on redundant mechanisms like ECC systems, the implementations described herein may conserve processing resources and/or may reduce power consumption and latency otherwise associated with ECC systems. In this way, the implementations described herein may contribute to a more reliable and stable operation of NAND-based SSDs or similar memory systems, enhancing system efficiency and resource utilization without substantial alterations to existing designs or operations.

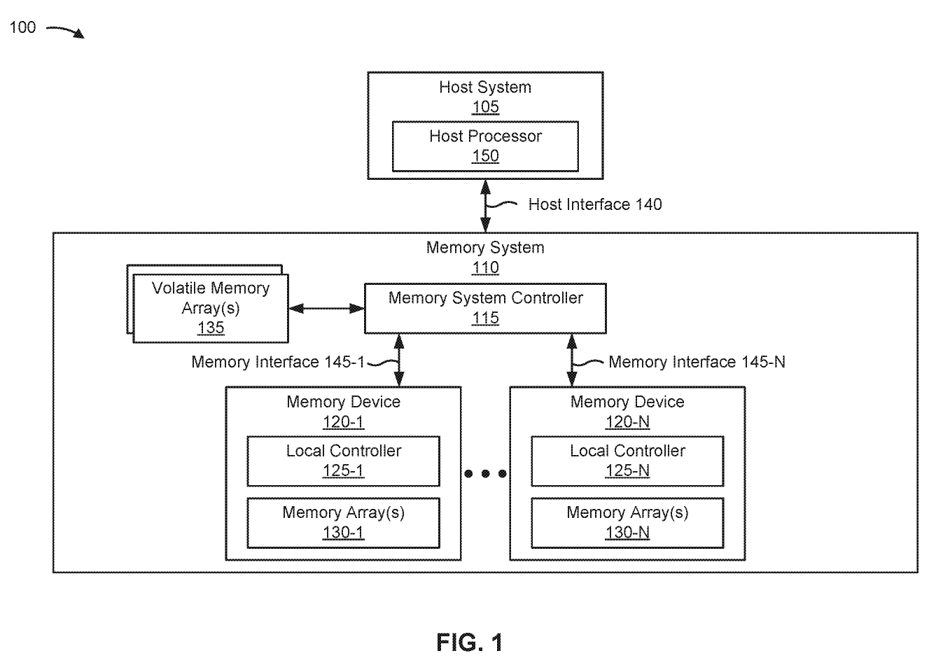

FIG. 1 is a diagram illustrating an example system 100 capable of detecting and correcting LBA mismatch conditions in a memory system. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a nonvolatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a nonvolatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both nonvolatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to nonvolatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a nonvolatile memory interface (e.g., for communicating with nonvolatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or nonvolatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive a memory access request indicating a LBA associated with a portion of a nonvolatile memory subsystem of the memory system; determine, using a logical-to-physical (L2P) data structure stored in a volatile memory subsystem of the memory system, a physical address associated with the LBA; detect an LBA mismatch condition associated with the physical address; perform a physical-to-logical (P2L) rebuild operation to determine a correct L2P association for the LBA; and store the correct L2P association in the L2P data structure.

In some implementations, one or more systems, devices, apparatuses, components, and/or controllers of FIG. 1 may be configured to detect, using a tag-checker procedure, an L2P mismatch condition associated with a DRAM subsystem of the memory system; trigger, based on detecting the L2P mismatch condition, a P2L rebuild procedure to determine a correct L2P association for the DRAM subsystem; execute a post-package repair (PPR) operation on an address associated with the DRAM subsystem that corresponds to the detected L2P mismatch condition; and write the correct L2P association to a memory location associated with the DRAM subsystem.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

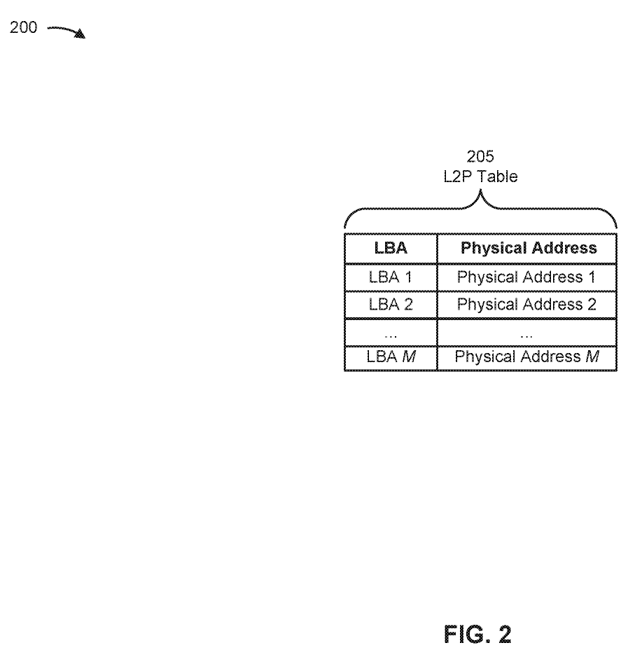

FIG. 2 is a diagram illustrating an example 200 of an L2P table 205. For example, FIG. 2 depicts an example of memory address translation. As shown in FIG. 2, the memory system 110 may store one or more address translation tables. An address translation table may be referred to as an L2P data structure, an L2P mapping table, an L2P address table, or an L2P table, and may be used to translate a logical memory address to a physical memory address.

For example, the memory system 110 may receive a command (e.g., from a host system 105), and the command may indicate a logical memory address, such as an LBA, which is sometimes called a host address. The memory system 110 may use one or more address translation tables to identify a physical memory address (sometimes called a physical address) corresponding to the logical memory address. For example, a read command may indicate an LBA from which data is to be read, or a write command may indicate an LBA to which data is to be written (or to overwrite data previously written to that LBA). The memory system 110 may translate that LBA (or multiple LBAs) to a physical address associated with the memory system 110 (e.g., a physical address in a memory array 130) using an L2P table (or multiple L2P tables). The physical address may indicate a physical location in nonvolatile memory, such as a die, a plane, a block, a page, and/or a portion of the page where the data is located.

In some implementations, the memory system 110 may use a logical address called a translation unit (TU), which may correspond to one or more LBAs. For example, an entry in an L2P table may indicate a mapping between a TU (e.g., indicated by a TU index value) and a physical address where data associated with that TU is stored. In some implementations, the physical address may indicate a die, a plane, a block, and a page of the TU. In other examples, the physical address may indicate a die, a plane, a block, and/or a page where data associated with an LBA is written or programmed to.

The memory system 110 may use an L2P table 205 for performing L2P address translations. For example, the L2P table 205 may map logical addresses (e.g., LBAs) to physical addresses in a nonvolatile memory of the memory system 110 (e.g., physical addresses in one or more memory arrays 130 of the memory system 110). Although an LBA is described herein as an example of a logical address included in the L2P table 205, other logical addresses or logical units, such as a TU, or a set of LBAs, among other examples, may be used in a similar manner as described herein. In some implementations, the L2P table 205 may be an entire L2P table. In other implementations, the L2P table 205 may be a portion of an L2P table (e.g., a set of entries of the L2P table and/or an address range associated with the L2P table), and/or a physical page table (PPT) associated with an L2P table, among other examples. For example, the L2P table 205 may include a set of LBA and physical address pairs (e.g., a pair may include an LBA and the corresponding physical address, associated with the LBA, in nonvolatile memory).

In some examples, an L2P data structure, such as the L2P table 205, may be stored in a volatile memory subsystem (e.g., volatile memory arrays 135) of a memory system (e.g., memory system 110), such as within DRAM of an SSD. In such examples, when the DRAM encounters an uncorrectable error, overall system performance may be impacted. For example, in NAND-based SSD systems, in which the DRAM may be used for L2P lookup (e.g., to store the L2P table 205), an uncorrectable error at the DRAM may lead to LBA mismatches (e.g., instances in which an L2P lookup returns an incorrect physical address for a given LBA), resulting in degradation of overall system performance.

In some examples, a memory system may be configured to identify LBA mismatch conditions (sometimes referred to herein as L2P mismatch conditions), such as for a purpose of reducing silent data corruption (SDC), among other examples. For example, a NAND-based SSD may employ a tag-based mismatch handling procedure intended to reduce SDC. In such examples, however, the error that caused the LBA mismatch condition in the first place may persist on the DRAM, because the tag-based mismatch handling procedure may only catch, but not correct, LBA mismatch conditions. Accordingly, every time the memory address associated with the LBA mismatch condition is accessed, there may be an AFR event.

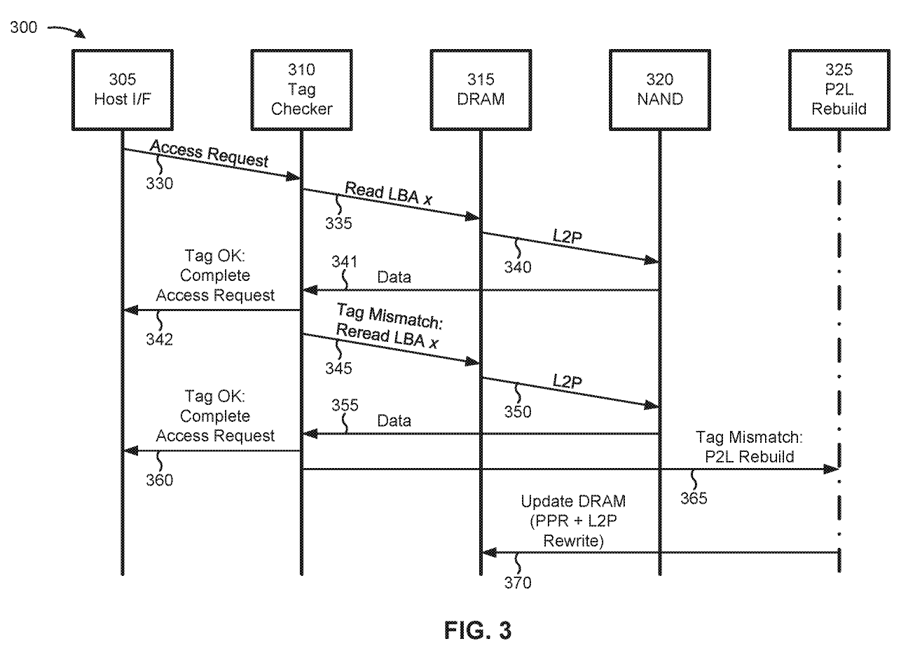

According to some techniques described herein, a memory system may be capable of both identifying an LBA mismatch condition as well as correcting the LBA mismatch condition, reducing AFR events associated with the memory system, reducing memory operation errors associated with the memory system, and reducing power, computing, and storage consumption otherwise associated with correcting errors associated with the memory system. Aspects of identifying and correcting LBA mismatch conditions are described in more detail below in connection with FIGS. 3-5.

As indicated above, FIG. 2 is provided as an example. Other examples may differ from what is described with regard to FIG. 2.

FIG. 3 is a diagram of an example implementation 300 associated with detecting and correcting LBA mismatch conditions in a memory system. As shown in FIG. 3, example implementation 300 includes a host interface (I/F) component 305, a tag checker component 310, a volatile memory subsystem component 315 (e.g., a DRAM component), a nonvolatile memory subsystem component 320 (e.g., a NAND component), and/or a P2L rebuild component 325. The operations described in connection with FIG. 3 may be performed by the memory system 110 and/or one or more components of the memory system 110, such as the memory system controller 115, one or more memory devices 120, and/or one or more local controllers 125. For example, the host interface component 305 may be associated with and/or correspond to the host interface 140 of the memory system 110, the tag checker component 310 may be associated with and/or correspond to the memory system controller 115 of the memory system 110, the volatile memory subsystem component 315 may be associated with and/or correspond to the volatile memory arrays 135 of the memory system 110, the nonvolatile memory subsystem component 320 may be associated with and/or correspond to the memory device 120 and/or a component therein (e.g., the local controller 125 and/or the memory arrays 130) of the memory system 110, and/or the P2L rebuild component 325 may be associated with and/or correspond to the memory system controller 115 of the memory system 110.

As shown by FIG. 3, and reference number 330, a memory system may receive a memory access request (e.g., a memory command) indicating an LBA associated with a portion of a nonvolatile memory subsystem of the memory system. For example, the memory system may receive a request from a host system (e.g., host system 105) to access data stored at a specific LBA (shown in FIG. 3 as “LBA x”) within the nonvolatile memory subsystem, such as a NAND memory subsystem. In some implementations, a volatile memory subsystem (e.g., DRAM) may be used to store an L2P data structure (e.g., L2P table 205), as described above in connection with FIG. 2. In such implementations, the tag checker component 310 may receive the memory access request, identify an LBA associated with the memory access request (e.g., LBA x), and/or may indicate the LBA associated with the memory access request to the volatile memory subsystem component 315, as indicated by reference number 335.

As shown by reference number 340, the memory system may determine a physical address associated with the LBA using an L2P data structure stored in a volatile memory subsystem of the memory system (e.g., stored in DRAM of the memory system). For example, the memory system may utilize an L2P lookup table stored within a volatile memory, such as DRAM, to translate the LBA (e.g., LBA x) to a corresponding physical memory location within a nonvolatile memory subsystem (e.g., NAND memory). The memory system may thus request access to data (e.g., user data) stored at the physical address indicated by the L2P data structure, and/or the nonvolatile memory subsystem component 320 may return the data (e.g., to the memory system controller 115, and, more particularly, to the tag checker component 310), as indicated by reference number 341.

In some aspects, the data returned by the nonvolatile memory subsystem component 320 may include metadata, such as a tag indicating a logical address associated with the data. A tag may be a piece of metadata associated with a memory address and/or data block that includes information used to verify the integrity and correctness of the data being accessed or stored. In such aspects, the tag checker component 310, which may be a component or mechanism that uses tags to verify data integrity, detect mismatches or errors, and/or trigger corrective actions to maintain the reliability and performance of the memory system, may compare the metadata (e.g., the tag) to the LBA indicated by the memory access request (e.g., LBA x) to ensure that the correct data was accessed. If the tag checker component 310 determines that the correct data was accessed (shown in connection with reference number 342 as “Tag OK”), the tag checker component 310 may cause the memory access request to be completed, such as by providing the data to the host system (e.g., host system 105) via the host interface component 305 (e.g., via host interface 140).

However, if the tag checker component 310 determines that the correct data was not accessed and/or that an LBA mismatch condition (e.g., a condition in which there is a discrepancy or inconsistency between the LBA that is provided by a host system (e.g., LBA x) and the tag included with data accessed by the memory system) has occurred, the tag checker component 310 may trigger a retry and/or reread mechanism in an effort to retrieve the correct user data. Put another way, in some implementations an LBA mismatch condition may not be indicative of an uncorrectable error in the volatile memory subsystem and/or a defect in the L2P data structure (e.g., the L2P table 205), but instead may simply have occurred due to a random error, noise in the channel, and/or similar conditions. Accordingly, in some implementations, the tag checker component 310 may, in response to detecting an LBA mismatch condition, trigger the retry mechanism to attempt to retrieve the correct data without resorting to a P2L rebuild mechanism or the like.

More particularly, as shown by reference number 345, the memory system may detect an LBA mismatch condition based on a tag that is stored in a memory location associated with the physical address not matching the LBA (e.g., LBA x). For example, the tag checker component 310 may discover that the LBA provided by the host does not correspond to the tag included with data retrieved from the physical memory location identified by the L2P data structure, indicating a possible error or data corruption. In such implementations, as further shown by reference number 345, the memory system may redetermine the physical address associated with the LBA based on detecting the LBA mismatch condition. For instance, the system may attempt to access the correct data by retrying the lookup process in the L2P data structure to find the accurate physical address corresponding to the original LBA.

In such implementations, and as indicated by reference number 350, the memory system may again determine a physical address associated with the LBA using an L2P data structure stored in a volatile memory subsystem of the memory system (e.g., stored in DRAM). For example, in a similar manner as described above in connection with reference number 340, the memory system may utilize an L2P lookup table stored within a volatile memory, such as DRAM, to translate the LBA (e.g., LBA x) to a corresponding physical memory location within the nonvolatile memory subsystem (e.g., NAND memory). The memory system may thus request access to data stored at the physical address indicated by the L2P data structure, and/or the nonvolatile memory subsystem component 320 may return the data (e.g., to the tag checker component 310), as indicated by reference number 355.

In a similar manner as described above in connection with reference numbers 342 and 345, upon receipt of the retrieved data, the tag checker component 310 may compare the metadata (e.g., the tag) to the LBA indicated by the memory access request (e.g., LBA x) to ensure that the correct data was accessed. If the tag checker component 310 determines that the correct data was accessed (shown in connection with reference number 360 as “Tag OK”), the tag checker component 310 may cause the memory access request to be completed, such as by providing the data to the host system (e.g., host system 105) via the host interface component 305. However, if the tag checker component 310 determines that the correct data was still not accessed and/or that an LBA mismatch condition has persisted, the tag checker component 310 may trigger a P2L rebuild procedure.

More particularly, as indicated by reference number 365, the memory system (e.g., the P2L rebuild component 325 of the memory system) may perform the P2L rebuild procedure to determine a correct L2P association for the LBA. In some implementations, the P2L rebuild procedure may include locating the correct physical address for the requested LBA (e.g., LBA x) by searching memory associated with the nonvolatile memory subsystem (e.g., NAND memory) to locate a tag associated with the LBA. Put another way, the P2L rebuild process may involve scanning through the nonvolatile memory to find the correct association between the LBA and its physical location in an effort to correct the error detected during the LBA mismatch condition.

As shown by reference number 370, upon determining the correct L2P association for the LBA (e.g., LBA x), the memory system may store the correct L2P association in the L2P data structure. For example, the memory system may update the L2P data structure (e.g., L2P table 205) to include the correct L2P association. Moreover, because the LBA mismatch condition may be indicative of persistent errors in the volatile memory subsystem component 315 (e.g., because the LBA mismatch condition may be indicative of a row failure in the DRAM, in which one or more entire rows of memory cells become defective and cannot reliably store or retrieve data, among other examples), the memory system may perform a PPR procedure for the volatile memory subsystem. A PPR procedure may be a method used to repair memory cells that exhibit defects or failures after the volatile memory (e.g., DRAM) modules have been packaged and assembled, such as by reconfiguring an internal address map of the volatile memory to replace a defective row or column with a spare one (e.g., a row or column reserved for use as substitution for a defective row or column).

In some implementations, a PPR procedure may be associated with a soft PPR procedure, which may involve temporary reconfiguration of the volatile memory subsystem and/or which may be performed dynamically while the memory module is in operation. As used herein, “temporarily” reconfiguring the volatile memory subsystem (e.g., DRAM) means reconfiguring the volatile memory subsystem in a way that does not persist across power-cycling of the volatile memory subsystem. A soft PPR procedure may not require a power cycle and/or system reboot, and/or a soft PPR procedure may leverage dynamic remapping to handle transient errors or non-permanent defects. In implementations in which the memory system performs a soft PPR procedure as part of the operations shown in connection with reference number 370, the memory system may store the correct L2P association in the L2P data structure in connection with performing the soft PPR procedure, such as by temporarily reconfiguring the volatile memory subsystem (e.g., DRAM) such that the portion of memory used to store the L2P association for the requested LBA (e.g., LBA x) is remapped to a spare row or column in the volatile memory subsystem, and/or by storing the correct L2P association in the spare row or column.

In some other implementations, a PPR procedure may be associated with a hard PPR procedure, which may involve permanent modifications to the memory configuration and/or which may be associated with physical changes to the volatile memory subsystem (e.g., DRAM), such as blowing fuses or reprogramming nonvolatile memory. In some implementations, hard PPR may be performed during maintenance cycles and/or may require the volatile memory subsystem module to be taken offline, power-cycled, and/or rebooted. In implementations in which the memory system performs a hard PPR procedure as part of the operations shown in connection with reference number 370, the memory system may store the correct L2P association in the L2P data structure in connection with performing the hard PPR procedure, such as by permanently reconfiguring the volatile memory subsystem (e.g., DRAM) such that the portion of memory used to store the L2P association for the requested LBA (e.g., LBA x) is remapped to a spare row or column in the volatile memory subsystem, and/or by storing the correct L2P association in the spare row or column. As used herein, “permanently” reconfiguring the volatile memory subsystem (e.g., DRAM) means reconfiguring the volatile memory subsystem in a way that persists across power-cycling of the volatile memory subsystem. In some implementations, the memory system may trigger a hard PPR procedure when a soft PPR procedure has previously been attempted but was not sufficient to rectify the error (e.g., the hard PPR procedure may be triggered when certain L2P mapping errors persist after a soft PPR procedure).

In this way, the memory system may utilize a combination of error detection and correction methods to maintain the integrity of data access in a managed memory system (e.g., an SSD) that combines a volatile memory subsystem (e.g., DRAM) with a nonvolatile memory subsystem (e.g., NAND). In some implementations, the memory system may leverage tags to identify inconsistencies in data requested and data retrieved, and/or may employ soft and/or hard PPR procedures to rectify errors, thereby improving system availability and reliability without the need for complex error correction coding hardware.

As indicated above, FIG. 3 is provided as an example. Other examples may differ from what is described with regard to FIG. 3. The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more functions described as being performed by another set of components shown in FIG. 3.

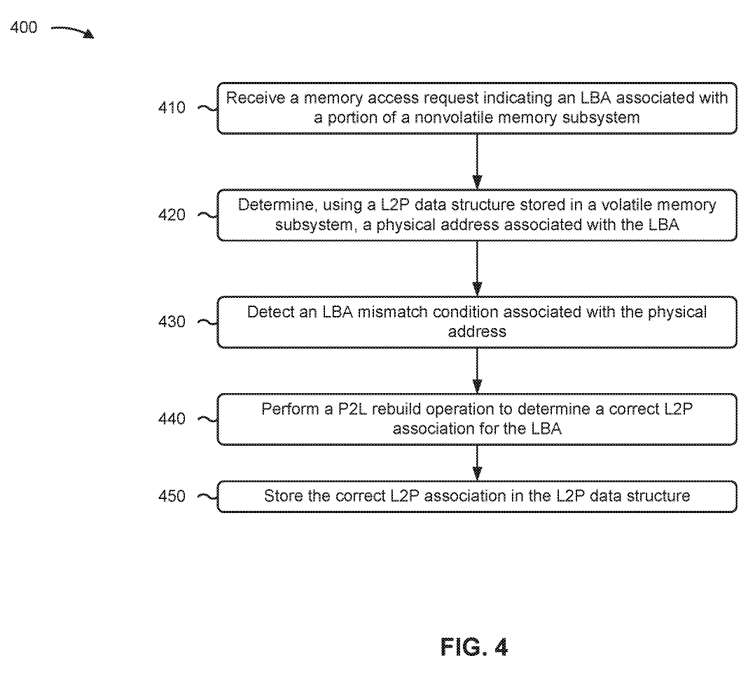

FIG. 4 is a flowchart of an example method 400 associated with detecting and correcting LBA mismatch conditions in a memory system. In some implementations, a memory system (e.g., the memory system 110) may perform or may be configured to perform the method 400. In some implementations, another device or a group of devices separate from or including the memory system (e.g., host system 105) may perform or may be configured to perform the method 400. Additionally, or alternatively, one or more components of the memory system (e.g., memory system controller 115, one or more memory devices 120, one or more local controllers 125, one or more memory arrays 130, one or more volatile memory arrays 135, the host interface component 305, the tag checker component 310, the volatile memory subsystem component 315, the nonvolatile memory subsystem component 320, and/or the P2L rebuild component 325) may perform or may be configured to perform the method 400. Thus, means for performing the method 400 may include the memory system and/or one or more components of the memory system. Additionally, or alternatively, a non-transitory computer-readable medium may store one or more instructions that, when executed by the memory system, cause the memory system to perform the method 400.

As shown in FIG. 4, the method 400 may include receiving a memory access request indicating an LBA associated with a portion of a nonvolatile memory subsystem of the memory system (block 410). For example, in a similar manner as described above in connection with reference number 330, the memory system may receive (e.g., via the host interface component 305) a memory access request indicating that LBA x of the nonvolatile memory subsystem (e.g., NAND memory) is to be accessed.

As further shown in FIG. 4, the method 400 may include determining, using a L2P data structure stored in a volatile memory subsystem of the memory system, a physical address associated with the LBA (block 420). For example, in a similar manner as described above in connection with reference numbers 335 and 340, the memory system (e.g., the volatile memory subsystem component 315 of the memory system) may determine a physical address associated with LBA x, such as by using an L2P data structure (e.g., L2P table 205) stored in the volatile memory subsystem (e.g., DRAM).

As further shown in FIG. 4, the method 400 may include detecting an LBA mismatch condition associated with the physical address (block 430). For example, in a similar manner as described above in connection with reference numbers 345 and 365, the memory system (e.g., the tag checker component 310 of the memory system) may detect an LBA mismatch condition, such as by comparing a tag included in metadata of the retrieved data to the LBA x requested by the host system and/or determining that the tag does not match the LBA x requested by the host system.

As further shown in FIG. 4, the method 400 may include performing a P2L rebuild operation to determine a correct L2P association for the LBA (block 440). For example, in a similar manner as described above in connection with 365, the memory system (e.g., the P2L rebuild component 325 of the memory system) may perform a P2L rebuild operation by searching the nonvolatile memory subsystem (e.g., NAND memory) for a tag corresponding to the requested LBA (e.g., LBA x) and/or identifying a physical address (e.g., a PBA) of a memory location storing the tag, such as for a purpose of determining a correct L2P association for LBA x.

As further shown in FIG. 4, the method 400 may include storing the correct L2P association in the L2P data structure (block 450). For example, in a similar manner as described above in connection with reference number 370, the memory system (e.g., the P2L rebuild component 325 of the memory system) may update the L2P data structure (e.g., L2P table 205) stored at the volatile memory subsystem (e.g., DRAM) to include the correct L2P association for LBA x, such that L2P lookup errors may not persist during future accesses of LBA x.

The method 400 may include additional aspects, such as any single aspect or any combination of aspects described below and/or described in connection with one or more other methods or operations described elsewhere herein.

In a first aspect, the volatile memory subsystem is associated with a DRAM subsystem, and the nonvolatile memory subsystem is associated with a NAND memory subsystem. For example, the volatile memory subsystem may be associated with the volatile memory arrays 135, which may be DRAM, and/or the nonvolatile memory subsystem may be associated with the memory arrays 130, which may be NAND.

In a second aspect, alone or in combination with the first aspect, storing the correct L2P association in the L2P data structure includes storing the correct L2P association in the L2P data structure as part of a soft post-package repair procedure associated with the volatile memory subsystem. For example, in a similar manner as described above in connection with reference number 370, the memory system (e.g., the P2L rebuild component 325 of the memory system) may store the correct L2P association in the L2P data structure in connection with performing the soft PPR procedure, such as by temporarily reconfiguring the volatile memory subsystem (e.g., DRAM) such that the portion of memory used to store the L2P association for LBA x is remapped to a spare row or column in the volatile memory subsystem, and/or by storing the correct L2P association in the spare row or column.

In a third aspect, alone or in combination with one or more of the first and second aspects, storing the correct L2P association in the L2P data structure includes storing the correct L2P association in the L2P data structure as part of a hard post-package repair procedure associated with the volatile memory subsystem. For example, in a similar manner as described above in connection with reference number 370, the memory system (e.g., the P2L rebuild component 325 of the memory system) may store the correct L2P association in the L2P data structure in connection with performing the hard PPR procedure, such as by permanently reconfiguring the volatile memory subsystem (e.g., DRAM) such that the portion of memory used to store the L2P association for LBA x is remapped to a spare row or column in the volatile memory subsystem, and/or by storing the correct L2P association in the spare row or column.

In a fourth aspect, alone or in combination with one or more of the first through third aspects, the method 400 includes redetermining, by the memory system and using the L2P data structure, the physical address associated with the LBA based on detecting the LBA mismatch condition. For example, in a similar manner as described above in connection with reference number 345, in response to detecting an LBA mismatch condition, the memory system (e.g., the tag checker component 310 of the memory system) may trigger a retry mechanism to attempt to retrieve the correct data without resorting to a P2L rebuild mechanism.

In a fifth aspect, alone or in combination with one or more of the first through fourth aspects, performing the P2L rebuild operation includes locating a correct physical address by searching memory associated with the nonvolatile memory subsystem to locate a tag associated with the LBA. For example, in a similar manner as described above in connection with reference number 365, the memory system (e.g., the P2L rebuild component 325 of the memory system) may search the nonvolatile memory subsystem (e.g., NAND) to locate a physical address (e.g., PBA) storing data that includes metadata (e.g., a tag) matching the requested LBA (e.g., LBA x).

In a sixth aspect, alone or in combination with one or more of the first through fifth aspects, detecting the LBA mismatch condition is based on a tag that is stored in a memory location associated with the physical address not matching the LBA. For example, in a similar manner as described above in connection with reference number 345, the memory system (e.g., the tag checker component 310 of the memory system) may detect the LBA mismatch condition by comparing metadata (e.g., the tag) included with retrieved user data to the LBA indicated by the memory access request (e.g., LBA x) to ensure that the correct data was accessed and/or may detect an LBA mismatch condition when the tag does not match the LBA x.

In a seventh aspect, alone or in combination with one or more of the first through sixth aspects, the L2P data structure is an L2P lookup table. For example, the L2P data structure may be the L2P table 205 described above in connection with FIG. 2.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

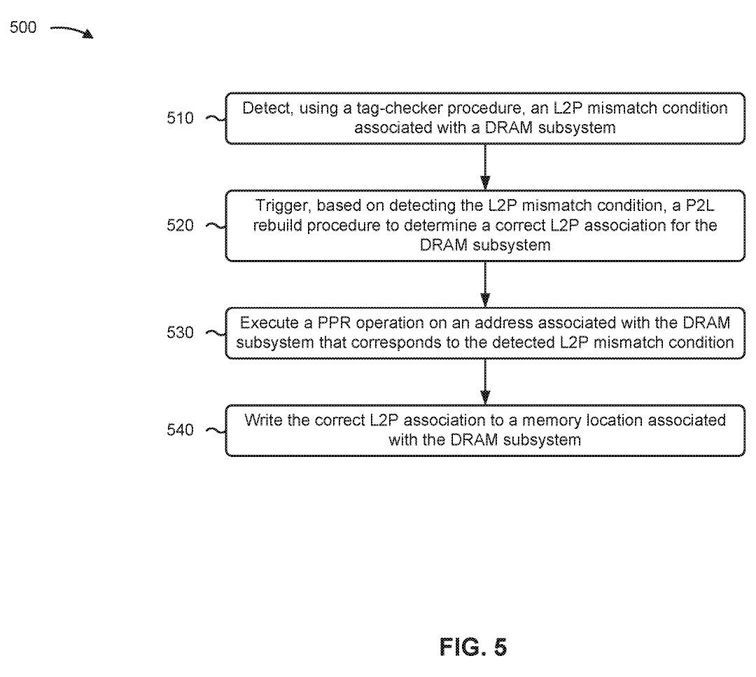

FIG. 5 is a flowchart of an example method 500 associated with detecting and correcting LBA mismatch conditions in a memory system. In some implementations, a memory system (e.g., the memory system 110) may perform or may be configured to perform the method 500. In some implementations, another device or a group of devices separate from or including the memory system (e.g., host system 105) may perform or may be configured to perform the method 500. Additionally, or alternatively, one or more components of the memory system (e.g., memory system controller 115, one or more memory devices 120, one or more local controllers 125, one or more memory arrays 130, one or more volatile memory arrays 135, the host interface component 305, the tag checker component 310, the volatile memory subsystem component 315, the nonvolatile memory subsystem component 320, and/or the P2L rebuild component 325) may perform or may be configured to perform the method 500. Thus, means for performing the method 500 may include the memory system and/or one or more components of the memory system. Additionally, or alternatively, a non-transitory computer-readable medium may store one or more instructions that, when executed by the memory system, cause the memory system to perform the method 500.

As shown in FIG. 5, the method 500 may include detecting, using a tag-checker procedure, an L2P mismatch condition associated with a DRAM subsystem of the memory system (block 510). For example, in a similar manner as described above in connection with reference numbers 345 and 365, the memory system (e.g., the tag checker component 310 of the memory system) may detect an L2P mismatch condition (e.g., an LBA mismatch condition), such as by comparing a tag included in metadata of retrieved data to the LBA x requested by the host system and/or by determining that the tag does not match the LBA x.

As further shown in FIG. 5, the method 500 may include triggering, based on detecting the L2P mismatch condition, a P2L rebuild procedure to determine a correct L2P association for the DRAM subsystem (block 520). For example, in a similar manner as described above in connection with reference number 365, the memory system (e.g., the P2L rebuild component 325 of the memory system) may trigger a P2L rebuild procedure that includes searching the nonvolatile memory subsystem (e.g., NAND memory) for a tag corresponding to the requested LBA (e.g., LBA x) and/or identifying a physical address (e.g., PBA) associated with a memory location used to store the data associated with the tag, such as for a purpose of determining a correct L2P association for LBA x.

As further shown in FIG. 5, the method 500 may include executing a PPR operation on an address associated with the DRAM subsystem that corresponds to the detected L2P mismatch condition (block 530). For example, in a similar manner as described above in connection with reference number 370, the memory system (e.g., the P2L rebuild component 325 of the memory system) may perform a soft PPR procedure, such as by temporarily reconfiguring the volatile memory subsystem (e.g., DRAM) such that the portion of memory used to store the L2P association for LBA x is remapped to a spare row or column in the volatile memory subsystem, and/or by performing a hard PPR procedure, such as by permanently reconfiguring the volatile memory subsystem (e.g., DRAM) such that the portion of memory used to store the L2P association for LBA x is remapped to a spare row or column in the volatile memory subsystem.

As further shown in FIG. 5, the method 500 may include writing the correct L2P association to a memory location associated with the DRAM subsystem (block 540). For example, in a similar manner as described above in connection with reference number 370, the memory system (e.g., the P2L rebuild component 325 of the memory system) may write the correct L2P association for LBA x in the volatile memory subsystem (e.g., DRAM), such that L2P lookup errors may not persist during future accesses of LBA x.

The method 500 may include additional aspects, such as any single aspect or any combination of aspects described below and/or described in connection with one or more other methods or operations described elsewhere herein.

In a first aspect, the PPR operation is a soft PPR operation associated with reassigning the address associated with the DRAM subsystem to a spare row in the DRAM subsystem. For example, in a similar manner as described above in connection with reference number 370, the memory system (e.g., the P2L rebuild component 325 of the memory system) may store the correct L2P association in the L2P data structure in connection with performing the soft PPR procedure, such as by temporarily reconfiguring the volatile memory subsystem (e.g., DRAM) such that the portion of memory used to store the L2P association for LBA x is remapped to a spare row or column in the volatile memory subsystem, and/or by storing the correct L2P association in the spare row or column.

In a second aspect, alone or in combination with the first aspect, the PPR operation is a hard PPR operation associated with permanently repairing the address associated with the DRAM subsystem during a reboot sequence. For example, in a similar manner as described above in connection with reference number 370, the memory system (e.g., the P2L rebuild component 325 of the memory system) may store the correct L2P association in the L2P data structure in connection with performing the hard PPR procedure, such as by permanently reconfiguring the volatile memory subsystem (e.g., DRAM) during a reboot sequence such that the portion of memory used to store the L2P association for LBA x is remapped to a spare row or column in the volatile memory subsystem, and/or by storing the correct L2P association in the spare row or column.

In a third aspect, alone or in combination with one or more of the first and second aspects, the L2P mismatch condition is associated with an expected LBA not matching an LBA read from a memory location. For example, in a similar manner as described above in connection with reference number 345, the memory system (e.g., the tag checker component 310 of the memory system) may detect the L2P mismatch condition by comparing metadata (e.g., the tag indicating an LBA) included with retrieved user data to the LBA indicated by the memory access request (e.g., LBA x) to ensure that the correct data was accessed and/or may detect an L2P mismatch condition when the tag does not match the LBA x.

In a fourth aspect, alone or in combination with one or more of the first through third aspects, the P2L mapping rebuild procedure is associated with searching a memory location for a LBA associated with the L2P mismatch condition. For example, in a similar manner as described above in connection with reference number 365, the memory system (e.g., the P2L rebuild component 325 of the memory system) may search the nonvolatile memory subsystem (e.g., NAND) to locate a physical address (e.g., PBA) storing data that includes metadata (e.g., a tag indicating an LBA) matching the requested LBA (e.g., LBA x).

In a fifth aspect, alone or in combination with one or more of the first through fourth aspects, writing the correct L2P association to the memory location associated with the DRAM subsystem includes updating an L2P lookup table associated with the DRAM subsystem. For example, in a similar manner as described above in connection with reference number 370, the memory system (e.g., the P2L rebuild component 325 of the memory system) may update an L2P lookup table (e.g., L2P table 205 described above in connection with FIG. 2) stored in DRAM of the memory system.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a method includes receiving, by a memory system, a memory access request indicating a logical block address (LBA) associated with a portion of a nonvolatile memory subsystem of the memory system; determining, by the memory system and using a logical-to-physical (L2P) data structure stored in a volatile memory subsystem of the memory system, a physical address associated with the LBA; detecting, by the memory system, an LBA mismatch condition associated with the physical address; performing, by the memory system, a physical-to-logical (P2L) rebuild operation to determine a correct L2P association for the LBA; and storing, by the memory system, the correct L2P association in the L2P data structure.

In some implementations, a memory system includes one or more components configured to: detect, using a tag-checker procedure, a logical-to-physical (L2P) mismatch condition associated with a dynamic random-access memory (DRAM) subsystem of the memory system; trigger, based on detecting the L2P mismatch condition, a physical-to-logical (P2L) rebuild procedure to determine a correct L2P association for the DRAM subsystem; execute a post-package repair (PPR) operation on an address associated with the DRAM subsystem that corresponds to the detected L2P mismatch condition; and write the correct L2P association to a memory location associated with the DRAM subsystem.

In some implementations, a solid state drive (SSD) memory system includes a dynamic random access memory (DRAM) subsystem; a NAND memory subsystem; and a memory system controller, wherein the memory system controller is configured to: receive, from a host system, a memory access request indicating a logical block address (LBA) associated with a portion of the NAND memory subsystem; determine, using a logical-to-physical (L2P) data structure stored in the DRAM subsystem, a physical address associated with the LBA; detect an LBA mismatch condition associated with the physical address; perform a physical-to-logical (P2L) rebuild operation to determine a correct L2P association for the LBA; and store the correct L2P association in the L2P data structure.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a memory system, a memory access request indicating a logical block address (LBA) associated with a portion of a nonvolatile memory subsystem of the memory system;
determining, by the memory system and using a logical-to-physical (L2P) data structure stored in a volatile memory subsystem of the memory system, a physical address associated with the LBA;
detecting, by the memory system, an LBA mismatch condition associated with the physical address;
performing, by the memory system, a physical-to-logical (P2L) rebuild operation to determine a correct L2P association for the LBA; and
storing, by the memory system, the correct L2P association in the L2P data structure.

2. The method of claim 1, wherein the volatile memory subsystem is associated with a dynamic random access memory (DRAM) subsystem, and wherein the nonvolatile memory subsystem is associated with a NAND memory subsystem.

3. The method of claim 1, wherein storing the correct L2P association in the L2P data structure includes storing the correct L2P association in the L2P data structure as part of a soft post-package repair procedure associated with the volatile memory subsystem.

4. The method of claim 1, wherein storing the correct L2P association in the L2P data structure includes storing the correct L2P association in the L2P data structure as part of a hard post-package repair procedure associated with the volatile memory subsystem.

5. The method of claim 1, further comprising redetermining, by the memory system and using the L2P data structure, the physical address associated with the LBA based on detecting the LBA mismatch condition.

6. The method of claim 1, wherein performing the P2L rebuild operation includes locating a correct physical address by searching memory associated with the nonvolatile memory subsystem to locate a tag associated with the LBA.

7. The method of claim 1, wherein detecting the LBA mismatch condition is based on a tag that is stored in a memory location associated with the physical address not matching the LBA.

8. The method of claim 1, wherein the L2P data structure is an L2P lookup table.

9. A memory system, comprising:
one or more components configured to:
detect, using a tag-checker procedure, a logical-to-physical (L2P) mismatch condition associated with a dynamic random-access memory (DRAM) subsystem of the memory system;
trigger, based on detecting the L2P mismatch condition, a physical-to-logical (P2L) rebuild procedure to determine a correct L2P association for the DRAM subsystem;
execute a post-package repair (PPR) operation on an address associated with the DRAM subsystem that corresponds to the detected L2P mismatch condition; and
write the correct L2P association to a memory location associated with the DRAM subsystem.

10. The memory system of claim 9, wherein the PPR operation is a soft PPR operation associated with reassigning the address associated with the DRAM subsystem to a spare row in the DRAM subsystem.

11. The memory system of claim 9, wherein the PPR operation is a hard PPR operation associated with permanently repairing the address associated with the DRAM subsystem during a reboot sequence.

12. The memory system of claim 9, wherein the L2P mismatch condition is associated with an expected logical block address (LBA) not matching an LBA read from a memory location.

13. The memory system of claim 9, wherein the P2L mapping rebuild procedure is associated with searching a memory location for a logical block address (LBA) associated with the L2P mismatch condition.

14. The memory system of claim 9, wherein the one or more components, to write the correct L2P association to the memory location associated with the DRAM subsystem, are configured to update an L2P lookup table associated with the DRAM subsystem.

15. A solid state drive (SSD) memory system, comprising:
a dynamic random access memory (DRAM) subsystem;
a NAND memory subsystem; and
a memory system controller, wherein the memory system controller is configured to:
receive, from a host system, a memory access request indicating a logical block address (LBA) associated with a portion of the NAND memory subsystem;
determine, using a logical-to-physical (L2P) data structure stored in the DRAM subsystem, a physical address associated with the LBA;
detect an LBA mismatch condition associated with the physical address;
perform a physical-to-logical (P2L) rebuild operation to determine a correct L2P association for the LBA; and
store the correct L2P association in the L2P data structure.

16. The SSD memory system of claim 15, wherein the memory system controller, to store the correct L2P association in the L2P data structure, is configured to store the correct L2P association in the L2P data structure as part of a soft post-package repair procedure associated with the DRAM subsystem.

17. The SSD memory system of claim 15, wherein the memory system controller, to store the correct L2P association in the L2P data structure, is configured to store the correct L2P association in the L2P data structure as part of a hard post-package repair procedure associated with the DRAM subsystem.

18. The SSD memory system of claim 15, wherein the memory system controller is further configured to redetermine, using the L2P data structure, the physical address associated with the LBA based on detecting the LBA mismatch condition.

19. The SSD memory system of claim 15, wherein the memory system controller, to perform the P2L rebuild operation, is configured to locate a correct physical address by searching NAND memory to locate a tag associated with the LBA.

20. The SSD memory system of claim 15, wherein the memory system controller, to detect the LBA mismatch condition, is configured to detect the LBA mismatch condition based on a tag that is stored in a NAND memory location associated with the physical address not matching the LBA.
